(19) United States
(12) Patent Application Publication
(10) Pub. No.: US 2025/0210647 A1
(43) Pub. Date: Jun. 26, 2025

(54) A PROCESS FOR PREPARING CATHODE ACTIVE MATERIALS AND OBTAINED CATHODE ACTIVE MATERIALS THEREOF

(71) Applicant: BASF SE, Ludwigshafen Am Rhein (DE)

(72) Inventors: Hao Xuan ZHANG, Shanghai (CN); Yu Han ZHANG, Shanghai (CN); Xiao Hang LIU, Shanghai (CN); Feng CHEN, Shanghai (CN); Jun Qing YAN, Beijing (CN); Hao HUANG, Beijing (CN); Wei Dong ZHOU, Beijing (CN)

(21) Appl. No.: 18/851,914

(22) PCT Filed: Apr. 12, 2023
(86) PCT No.: PCT/EP23/59568

§ 371 Date: Sep. 27, 2024

(30) Foreign Application Priority Data
Apr. 18, 2022 (WO) PCT/CN22/87429

(51) Int. Cl. H01M 4/525; C01G 53/506; H01M 4/02; H01M 4/131; H01M 4/62

(52) U.S. Cl. CPC H01M 4/525; C01G 53/506; H01M 4/131; H01M 4/625; C01P 2002/50; C01P 2002/60; C01P 2002/74; C01P 2002/76; C01P 2004/03; C01P 2006/11; C01P 2006/40; H01M 2004/028

(57) ABSTRACT

Disclosed herein a process for preparing a cathode active material of Formula (I) LiNiₓCo_{y}Mn_{z}O₂, including steps of: i) preparing a precursor of hydroxides or carbonates of Ni, Co and Mn; ii) mixing the precursor obtained from step i) with a source of Li; and iii) calcining the mixture obtained from step ii), where step iii) includes multi-step calcination, where x is in a range of from 0.80 to 0.95 and preferably from 0.80 to 0.92, y is in a range of from 0.01 to 0.15 and preferably from 0.01 to 0.12, and z is in a range of from 0.01 to 0.15 and preferably from 0.01 to 0.12, and the sum of x, y and z is 1.

### TECHNICAL FIELD

The present invention relates to a process for preparing a cathode active material, more specifically relates to a process for preparing a cathode active material having single crystalline of octahedra structures.

### BACKGROUND

Lithium ion batteries are widely used in various fields, from small devices such as mobile phones and laptop computers to car batteries and other batteries for e-mobilities. Electrodes, electrolytes and separators, as main parts of batteries decide together performances of batteries. Wherein, cathode active materials (CAM) account for about 30% of the total cost of battery manufacturing, which play a critical role in lithium ion battery technology. And commonly used cathode active materials include lithium iron phosphates, lithium cobalt oxides, and lithiated nickel-cobalt-manganese oxide (“NCM”).

NCM is a preferred choice since Li ions have higher diffusion rate and electron mobility and therefore a higher energy density is reached. And high-Ni NCM i.e. NCM having a Ni content of at least 80% by molar based on the total molar of Ni, Co and Mn, is developed to meet requirements of electric vehicles (EV) The examples of high-Ni NCM includes LiNi_{0.80}Co_{0.10}Mn_{0.10}O₂ (Ni80), LiNi_{0.83}Co_{0.12}Mn_{0.05}O₂ (Ni83), LiNi_{0.88}Co_{0.06}Mn_{0.06}O₂ (Ni88), LiNi_{0.90}Co_{0.05}Mn_{0.05}O₂ (Ni90) and LiNi_{0.92}Co_{0.04}Mn_{0.04}O₂ (Ni92).

In the meantime, single crystal CAM(SCM) also become more and more attractive because of less phase boundaries and exposed surfaces in comparison to the polycrystal materials, which can effectively reduce structural deterioration, electrolyte side reaction and gas generation and further improve cycling stability and safety of cathode active materials. However, SCM in the market show irregular and shapeless bulk morphology, which is apparently not in accordance with the definition of SCM i.e. regular polyhedron shape with distinct edges.

It is reported that adding Na₂SO₄ and NaCl as flux agent during calcination step of producing SCM can form well-shaped SCM, however, a washing step is required to remove residual Na₂SO₄ and NaCl, which brings additional cost and also makes the process more complicated especially when the preparation is scaled-up from lab to mass production.

Therefore, it is still required to provide a process to produce well-shaped SCM applicable for industrial scale.

### SUMMARY OF THIS INVENTION

In one aspect, this invention provides a process for preparing a cathode active material of Formula (I), comprising steps of

LiNiₓCo_{y}Mn_{z}O₂ (I)
i) preparing a precursor of hydroxides or carbonates of Ni, Co and Mn;
ii) mixing the precursor obtained from step i) with a source of Li; and
iii) calcining the mixture obtained from step ii), wherein said step iii) comprises multi-step calcination, wherein x is in a range of from 0.80 to 0.95 and preferably from 0.80 to 0.92, y is in a range of from 0.01 to 0.15 and preferably from 0.01 to 0.12, and z is in a range of from 0.01 to 0.15 and preferably from 0.01 to 0.12, and the sum of x, y and z is 1.

In another aspect, this invention provides a cathode active material of Formular (1) in single crystalline of octahedra structures

LiNiₓCo_{y}Mn_{z}O₂ (I)

wherein x is in a range of from 0.80 to 0.95 and preferably from 0.80 to 0.02, y is in a range of from 0.01 to 0.15 and from 0.01 to 0.12, and z is in a range of from 0.01 to 0.15 and preferably from 0.01 to 0.12, and the sum of a, b and c is 1; wherein the lattice parameters a, b, c is 2.88047 Å, 2.88047 Å and 14.20877 Å respectively, wherein it has an average particle size of 3.5 um to 4.5 um according to PSD (particle size distribution) measurement, a pressed density of from 3.0 g/ml to 4.0 g/ml tested by Powder Resistivity Measurement Unit MCP-PD51 provided by MITSUBISHI Mitsubishi Chemical Analytech Co., Ltd. and a conductivity of 0.004 S/m to 0.08 S/m according to JIS K7194/JIS R 1637.

In a further aspect, this invention provides a cathode comprising
(A) from 50% to 98.99% by weight of cathode active material obtained from the invented process,
(B) from 1% to 5% by weight of carbon in an electrically conductive state,
(C) from 0.01% to 5% by weight of a binder, and
(D) from 0 to 50% by weight of a solid electrolyte, based on the total weight of components (A), (B), (C) and (D).

### DETAILED DESCRIPTION OF THIS INVENTION

The present invention provides a process for preparing a cathode active material of Formula (I), comprising steps of

LiNiₓCo_{y}Mn_{z}O₂ (I)
i) preparing a precursor of hydroxides or carbonates of Ni, Co and Mn;
ii) mixing the precursor obtained from step i) with a source of Li; and
iii) calcining the mixture obtained from step ii), wherein said step iii) comprises multi-step calcination, wherein x is in a range of from 0.80 to 0.95 and preferably from 0.80 to 0.92, y is in a range of from 0.01 to 0.15 and preferably from 0.01 to 0.12, and z is in a range of from 0.01 to 0.15 and preferably from 0.01 to 0.12, and the sum of x, y and z is 1.

The cathode active material of Formula (I) is a high-Ni NCM product comprising at least 80% by molar of element Ni based on the total molar of elements Ni, Co and Mn. Examples may be LiNi_{0.80}Co_{0.10}Mn_{0.10}O₂ (Ni80), LiNi_{0.83}Co_{0.12}Mn_{0.05}O₂ (Ni83), LiNi_{0.88}Co_{0.06}Mn_{0.06}O₂ (Ni88), LiNi_{0.90}Co_{0.05}Mn_{0.05}O₂ (Ni90) and LiNi_{0.92}Co_{0.04}Mn_{0.04}O₂ (Ni92), preferably LiNi_{0.83}Co_{0.12}Mn_{0.05}O₂ (Ni83), LiNi_{0.88}Co_{0.06}Mn_{0.06}O₂ (Ni88), LiNi_{0.90}Co_{0.05}Mn_{0.05}O₂ (Ni90) and LiNi_{0.92}Co_{0.04}Mn_{0.04}O₂ (Ni92), more preferably LiNi_{0.88}Co_{0.06}Mn_{0.06}O₂ (Ni88), LiNi_{0.90}Co_{0.05}Mn_{0.05}O₂ (Ni90) and LiNi_{0.92}Co_{0.04}Mn_{0.04}O₂(Ni92), and even more preferably LiNi_{0.90}Co_{0.05}Mn_{0.05}O₂ (Ni90) and LiNi_{0.92}Co_{0.04}Mn_{0.04}O₂(Ni92).

Steps (i) to (iii) of the invented process are being performed in order and may be performed with or without one or more intermediate steps. In some embodiments, the precursor in step (i) may be prepared by co-precipitating Ni, Co and Mn as hydroxides. In this case, a solution containing water-soluble salts of nickel, cobalt and manganese is contacted with a base, for example a solution of alkali metal hydroxide or alkali metal carbonate, preferably a solution of alkali metal hydroxide. Examples of alkali metal hydroxides are potassium hydroxide and sodium hydroxide. Examples of alkali metal carbonate are sodium carbonate, sodium bicarbonate, potassium carbonate and potassium bicarbonate. The contact with a base can be performed by simultaneously feeding a base and a solution of one or more water-soluble salts of nickel, cobalt and manganese into a vessel, preferably under stirring. It is preferred to perform such contact by feeding a solution of alkali metal hydroxide and a solution comprising water-soluble salts of cobalt, nickel and manganese according to a molar ratio in Formula (I). Water-soluble in the context of the present invention shall mean that such a salt has a solubility of at least 20 g/I in distilled water at 20° C., the amount of salt being determined under omission of crystal water and of water stemming from aquo complexes. Water-soluble salts of nickel, cobalt and manganese may preferably be the respective water-soluble salts of Ni²⁺, Co²⁺, and Mn²⁺.

The co-precipitation in step (i) is preferably performed at temperatures in a range of from 10° C. to 85° C., more preferably from 20° C. to 60° C. The co-precipitation in step (i) is preferably performed at a pH value in a range from 8 to 13, more preferably from 11 to 12.5, and even more preferably 11.5 to 12.2, measured in a mother liquor at 23° C. The co-precipitation is performed under a pressure in a range from 0.5 bar to 20 bar, preferably under 1 atm.

A stoichiometric or excess amount of base, for example alkali metal hydroxide, is used based on the total molar of elements Ni, Co and Mn. The molar excess may, for example, be in a range of 1.01:1 or more and it is preferred to use a stoichiometric proportion. The aqueous solution of alkali metal hydroxide has a concentration in a range of from 1% to 50% by weight, preferably from 10% to 25% by weight. The concentrations of the aqueous solution of nickel, cobalt, and manganese salts can be selected within wide ranges, preferably, in a range of 1 mol/L to 1.8 mol/L of total molar of nickel, cobalt and manganese based on the volume of the solution, more preferably from 1.5 mol/L to 1.7 mol/L.

The co-precipitation in step (i) is performed in the presence of at least one compound L which may serve as a ligand for at least one of the transition metals, for example organic amine preferably ammonia. The concentration of compound L, such as ammonia, is preferably in a range of from 0.05 mol/L to 1 mol/L, more preferably from 0.1 mol/L to 0.7 mol/L. Preferably, the amounts of ammonia should be given to make the soluble Ni²⁺ ions in the mother liquor in amount of no more than 1000 ppm, more preferably no more than 500 ppm.

During the co-precipitation of step (i), mixing with a stirrer is preferred at a stirring speed of at least 1 W/1, more preferably at least 3 W/I and even more preferably at least 5 W/I and no more than 25 W/I. It is preferred not to use any reducing agent such as hydrazine, ascorbic acid, glucose, and alkali metal sulfites during the co-precipitation of step (i).

The co-precipitation in step (i) can be performed under air, under inert gas atmosphere, for example noble gas or nitrogen atmosphere, or under reduced atmosphere for example SO₂. And it is preferred to perform under air or inert gas atmosphere.

The co-precipitation in step (i) provides a mixed hydroxide or carbonate, preferably hydroxide of nickel, cobalt and manganese in form of particles slurry in the mother liquor. Said particles preferably have spherical shapes. Said spherical particles shall include not only the ones having exactly spherical shapes but also those particles of which the maximum and minimum diameters differ by no more than 10%, preferably no more than 5%.

In some embodiments of the present invention, the co-precipitation in step (i) is performed for a period of from 1 hour to 40 hours, preferably from 2 hours to 30 hours. And in some other embodiments, step (i) is carried out with intermediate steps, and the period excluding intermediate steps is in a range of from 1 hour to 40 hours, preferably from 2 hours to 30 hours.

The obtained precursor is removed from the mother liquor and dried in the presence of oxygen-containing atmosphere. Said removal can be achieved by filtration, centrifugation, decantation, spray drying, sedimentation or their combinations. Suitable apparatuses are, for example, filter presses, belt filters, spray dryers, hydrocyclones, inclined clarifiers or their combinations.

After removal, the precursor may be washed. Washing can be achieved, for example, with pure water or with an aqueous solution of alkali metal carbonate or alkali metal hydroxide, preferably with an aqueous solution of sodium carbonate, potassium carbonate, sodium hydroxide, potassium hydroxide or ammonia, more preferably water and aqueous solution of sodium hydroxide. The washing can be achieved, for example, with employment of elevated pressure or elevated temperature, for example from 30° C. to 50° C. In some embodiments, the washing is performed at room temperature. The efficiency of the washing can be checked by analytical measures. For example, the content of transition metal(s) in the washing water can be analyzed. If washing is achieved by water rather than an aqueous solution of alkali metal hydroxide, it is possible to take use of conductivity checking on the water after washing whether any water-soluble substances, for example water-soluble salts, can still be washed away.

After removal, drying may be performed in the presence of oxygen. Presence of oxygen in this context refers to the presence of gas containing oxygen, for example an atmosphere of air, pure oxygen, mixtures of oxygen and air, and air diluted with an inert gas such as nitrogen. The drying may be performed, for example, at a temperature in a range of from 30° C. to 150° C.

To perform step (ii) of the invented process, the precursor could be mixed with at least one source of lithium, for example at least one compound selected from Li₂O, LiOH and Li₂CO₃, and preferred source of lithium is Li₂CO₃. The amounts of the precursor and of the lithium compound are selected to obtain the stoichiometry in Formula (I).

The mixing in step (ii) may be carried out at an ambient temperature and under 1 atm. In some embodiments, the mixing is performed in a mixer, for example paddle mixer, plough-share mixer, free-fall mixer, roller mill, or high-shear mixer. And plough-share mixers are preferred. The mixing could be implemented with a speed in a range of from 5 rpm to 500 rpm, preferably from 5 rpm to 60 rpm. When a free-fall mixer is applied, a speed in a range of from 5 rpm to 25 rpm is preferable and more preferably from 5 rpm to 10 rpm. When a plough-share mixer is applied, a speed in a range of from 50 rpm to 400 rpm is preferable and more preferably from 100 rpm to 250 rpm. When a high-shear mixer is applied, a speed in a range of from 100 rpm to 950 rpm of the agitator and a speed in a range of from 100 rpm to 3750 rpm of the chopper are preferable.

To perform step (iii) of the invented process, the mixture of the precursor and the lithium compound is calcined by multi-steps. Said multi-steps comprising step A of heating at a temperature in a range of from 300° C. to 600° C. and preferably from 400° C. to 600° C. and step B of heating subsequent to step A, at a temperature in a range of from 750° C. to 900° C. and preferably from 750° C. to 850° C. Said step A has a period of from 1 hours to 7 hours and preferably from 3 hours to 5 hours. And said step B has a period of from 6 hours to 16 hours and preferably from 8 hours to 14 hours. From step A to step B, a heating rate of from 1 K/min up to 10 K/min can be applied, preferably from 2K/min to 5K/min. During step A, the heating temperature is kept stable within a fluctuation of ±5° C.

Step (iii) of the invented process can be performed in a furnace, for example, rotary tube furnace, muffle furnace, pendulum furnace, roller hearth furnace, push-through furnace and their combinations. In some embodiments, step (iii) is performed in an oxygen-containing atmosphere. Examples of oxygen-containing atmosphere include air, pure oxygen, mixtures of oxygen and air, and air diluted with an inert gas such as nitrogen. It is preferable to use an atmosphere of oxygen or oxygen diluted with air or nitrogen and a minimum content of oxygen of 21% by volume. In some other embodiments, step (iii) is carried out under an atmosphere with reduced CO₂ content, e.g. a carbon dioxide content in a range of from 0.01 ppm to 500 ppm by weight, preferable from 0.1 ppm to 50 ppm by weight. The CO₂ content may be determined by, e.g. optical methods using infrared light. More preferably, the step (iii) is implemented under an atmosphere having a carbon dioxide content below down limit that is detectable by optical methods using infrared light.

Step B comprises a transient thermal treatment (TTT). “Transient thermal treatment (TTT)” used herein means during the step B of step (iii), the temperature is increased by 100° C. to 450° C. compared with the baseline temperature of step B and is maintained for a short time. The temperature of the TTT can be in a range from 1000° C. to 1400° C., preferably from 1000° C. to 1200° C., such as from 1000° C. to 1100° C. The duration of the TTT may be from 1 min to 1 hour, preferably from 1 min to 30 mins, more preferably from 5 mins to 20 mins. During step B except for the period of TTT, the heating temperature is kept stable within a fluctuation of ±5° C.

The TTT is performed in an oxygen-containing atmosphere. Examples of oxygen-containing atmosphere include air, pure oxygen, mixtures of oxygen and air, air diluted with an inert gas such as nitrogen. In TTT, it is preferable to use an atmosphere of oxygen or oxygen diluted with air or nitrogen and a minimum content of oxygen of 21% by volume.

During the temperature change from baseline temperature of step B to that of the TTT, a heating rate of from 1K/min to 10K/min and preferably from 2K/min to 5 K/min, can be applied. During the temperature change from that of the TTT back to baseline temperature of step B, the same cooling down rate could be applied.

The TTT can be performed at any stage in step B, from the beginning to the end of step B. Preferably, the TTT can begin at the time point from 1/10 to 9/10, more preferably from ⅕ to ⅘ and even more preferably from ⅖ to ⅘, of the duration of step B.

Surprisingly, it has been found that by adding a TTT in the duration of step B, a single crystalline NCM which has homogeneous octahedral shape is obtained. Moreover, it shows the pressed density and electron conductivity of the single crystalline NCM are at least 3.257 g/mL and at least 0.022 S/m, respectively, approximately 7.0% and 1.5 times higher than the average levels (3.046 g/mL; 0.00873 S/m) in the market. As is known in the art, the pressed density is associated with the energy density in the battery, the bigger the pressed density is, the bigger energy density in the battery would be. On the other hand, the conductivity of the material is associated with the charge and discharge rate of the battery. Such a comparison indicates the potentials of standard SCM as cathode active materials are considerable. In addition, the high simplicity of TTT routine significantly overcomes the technical barrier for product scaling-up, which are more applicable in industrial production compared to the prior art.

A further aspect of the present invention is directed to electrodes comprising the single crystalline NCM obtained by the invented process. They are particularly useful for lithium-ion batteries. Lithium-ion batteries comprising at least one invented electrode exhibit a very good charge/discharge and high capacity. Electrodes comprising the single crystalline NCM obtained by the invented process are hereinafter also referred to as invented electrodes or electrodes according to the present invention, or as invented cathodes.

In some embodiments of the present invention, invented electrodes are in form of thin-film electrodes. Thin-film electrodes comprise invented electrode active material. Physical or chemical vapor deposition techniques may be used to produce the thin films. The electrode films have a thickness in a range of from 10 nm to 10,000 nm, preferably from 100 nm to 5,000 nm.

In some embodiments of the present invention, invented electrodes contain a current collector and
(A) the single crystalline NCM obtained by the invented process,
(B) carbon in an electrically conductive form,
(C) a binder, and
(D) optionally, a solid electrolyte.

In some embodiments of the present invention, invented electrodes contain a current collector and
(A) from 50% to 98.99% by weight of the single crystalline NCM obtained by the invented process,
(B) from 1% to 5% by weight of carbon in electrically conductive form,
(C) from 0.01% to 5% by weight of binder, and,
(D) from 0 to 50% by weight of a solid electrolyte, based on the total weight of components (A), (B), (C) and (D).

The current collector used in the invented electrodes may be such as, but not limited to, an aluminum foil.

Electrodes according to the present invention further contain carbon in electrically conductive form in brief also referred to as carbon (B). Carbon (B) can be selected from soot, active carbon, carbon nanotubes, graphene, and graphite. Carbon (B) can be added as such during preparation of electrode materials according to the invention.

In some embodiments, the amount of carbon (B) to invented electrode material is in a range of from 1% to 15% by weight, referring to the sum of components (A), (B), (C) and (D), preferably at least 2% by weight.

Invented electrodes may further comprise a binder (C). Suitable binders (C) are preferably selected from organic (co)polymers. Suitable (co)polymers, i.e. homopolymers or copolymers, can be selected, for example, from (co)polymers obtainable by anionic, catalytic or free-radical (co)polymerization, especially from polyethylene, polyacrylonitrile, polybutadiene, polystyrene, and copolymers of at least two comonomers selected from ethylene, propylene, styrene, (meth)acrylonitrile and 1,3-butadiene. Polypropylene is also suitable. Polyisoprene and polyacrylates are additionally suitable. Particular preference is given to polyacrylonitrile. In the context of the present invention, polyacrylonitrile is understood to mean not only polyacrylonitrile homopolymers but also copolymers of acrylonitrile with 1,3-butadiene or styrene. Preference is given to polyacrylonitrile homopolymers.

In the context of the present invention, polyethylene is not only understood to mean homopolyethylene, but also copolymers of ethylene which comprise at least 50 mol % of copolymerized ethylene and up to 50 mol % of at least one further comonomer, for example α-olefins such as propylene, butylene (1-butene), 1-hexene, 1-octene, 1-decene, 1-dodecene, 1-pentene, and also isobutene, vinylaromatics, for example styrene, and also (meth)acrylic acid, vinyl acetate, vinyl propionate, C₁-C₁₀-alkyl esters of (meth)acrylic acid, especially methyl acrylate, methyl methacrylate, ethyl acrylate, ethyl methacrylate, n-butyl acrylate, 2-ethylhexyl acrylate, n-butyl methacrylate, 2-ethylhexyl methacrylate, and also maleic acid, maleic anhydride, and itaconic anhydride. Polyethylene may be HDPE or LDPE.

In the context of the present invention, polypropylene is not only understood to mean homopolypropylene, but also copolymers of propylene which comprise at least 50 mol % of copolymerized propylene and up to 50 mol % of at least one further comonomer, for example ethylene and α-olefins such as butylene, 1-hexene, 1-octene, 1-decene, 1-dodecene and 1-pentene. Polypropylene is preferably isotactic or essentially isotactic polypropylene.

In the context of the present invention, polystyrene is not only understood to mean homopolymers of styrene, but also copolymers with acrylonitrile, 1,3-butadiene, (meth)acrylic acid, C₁-C₁₀-alkyl esters of (meth)acrylic acid, divinylbenzene, especially 1,3-divinylbenzene, 1,2-diphenylethylene, and α-methylstyrene.

Another preferred binder (C) is polybutadiene. Other suitable binders (C) are selected from polyethylene oxide (PEO), cellulose, carboxymethylcellulose, polyimides, and polyvinyl alcohol.

In some embodiments of the present invention, binders (C) are selected from those (co)polymers which have an average molecular weight M, in the range from 50,000 g/mol to 1,000,000 g/mol, preferably from 50,000 g/mol to 500,000 g/mol.

Binders (C) may be cross-linked or non-cross-linked (co)polymers. In a particularly preferred embodiment of the present invention, binders (C) are selected from halogenated (co)polymers, especially from fluorinated (co)polymers. Halogenated or fluorinated (co)polymers are understood to mean those (co)polymers which comprise at least one (co)polymerized (co)monomer which has at least one halogen atom or at least one fluorine atom per molecule, more preferably at least two halogen atoms or at least two fluorine atoms per molecule. Examples are polyvinyl chloride, polyvinylidene chloride, polytetrafluoroethylene, polyvinylidene fluoride (PVdF), tetrafluoroethylene-hexafluoropropylene copolymers, vinylidene fluoride-hexafluoropropylene copolymers (PVdF-HFP), vinylidene fluoride-tetrafluoroethylene copolymers, perfluoroalkyl vinyl ether copolymers, ethylene-tetrafluoroethylene copolymers, vinylidene fluoride-chlorotrifluoroethylene copolymers, and ethylene-chlorofluoroethylene copolymers.

Suitable binders (C) are especially polyvinyl alcohol and halogenated (co)polymers, for example polyvinyl chloride or polyvinylidene chloride, especially fluorinated (co)polymers such as polyvinyl fluoride and especially polyvinylidene fluoride and polytetrafluoroethylene.

Invented electrodes may comprise from 0.01% to 5% by weight of binder(s) (C), referring to the sum of components of (A), (B), (C) and (D). Solid electrolytes (D) are lithium ion conductive materials that are solid at temperatures of at least 30° C., preferably at least 50° C. Examples of solid electrolytes (D) are preferably lithium ion conductive materials such as lithium ion conductive ceramics, sintered ceramics, glass-ceramics, glasses, and polymer compounds. Preferred solid electrolytes (D) exhibit a conductivity for lithium ions of higher than 10⁻⁷ S/cm at 25° C., preferably in the range of 1·10⁻⁶ S/cm-5·10⁻² S/cm at 25° C. In particular, ceramic materials with perovskite, Nasicon, Thio-Lisicon, argyrodite or garnet related crystal structure offer good conductivities, but inorganic phosphorous and sulfur containing materials are suitable. Polymer based electrolytes contain at least one polymer from the list: polyethers, polyesters, polyimides, polyketones, polycarbonates, polyamides, poly-sulfides, polysulfones, polyurethanes, polyacrylates, polyolefines, styrenic polymers, vinyl polymers, fluoropolymers, polyphosphazenes, polysiloxanes, polysilazanes, boron polymers, liquid crystal polymers (LCP), polyacetylenes, polyanilines, polyfuranes, polyphenylenes, polypyrroles, polythiophenes or blends of at least two of the aforementioned polymers.

A further aspect of the present invention is an electrochemical cell, comprising
at least one invented electrode as cathode,
at least one anode, and
at least one electrolyte.

Embodiments of cathode have been described above in detail. The anode and the electrolyte are those commonly used in the art. Anode may contain at least one anode active material commonly used in the art, such as carbon (graphite), lithium metal, TiO₂, lithium titanium oxide, silicon or tin. Anode may additionally contain a current collector, for example a metal foil such as a copper foil. Electrolyte may comprise at least one non-aqueous solvent, at least one electrolyte salt and, optionally, additives.

Non-aqueous solvents for electrolyte can be liquid or solid at room temperature and are preferably selected from among polymers, cyclic or acyclic ethers, cyclic and acyclic acetals and cyclic or acyclic organic carbonates.

Examples of suitable polymers are, in particular, polyalkylene glycols, preferably poly-C₁-C₄-alkylene glycols and in particular polyethylene glycols. Polyethylene glycols can here comprise up to 20% by molar of one or more C₁-C₄-alkylene glycols. Polyalkylene glycols are preferably polyalkylene glycols having two methyl or ethyl end caps.

The molecular weight M_{w} of suitable polyalkylene glycols and in particular suitable polyethylene glycols can be at least 400 g/mol. The molecular weight M, of suitable polyalkylene glycols and in particular suitable polyethylene glycols can be up to 5,000,000 g/mol, preferably up to 2,000,000 g/mol. Examples of suitable acyclic ethers are, for example, diisopropyl ether, di-n-butyl ether, 1,2-dimethoxyethane, 1,2-diethoxyethane, with preference being given to 1,2-dimethoxyethane. Examples of suitable cyclic ethers are tetrahydrofuran and 1,4-dioxane. Examples of suitable acyclic acetals are, for example, dimethoxymethane, diethoxymethane, 1,1-dimethoxyethane, and 1,1-diethoxyethane. Examples of suitable cyclic acetals are 1,3-dioxane and in particular 1,3-dioxolane. Examples of suitable acyclic organic carbonates are dimethyl carbonate, ethyl methyl carbonate, and diethyl carbonate.

Examples of suitable cyclic organic carbonates are compounds of the general Formula (III.1) and Formula (III.2)

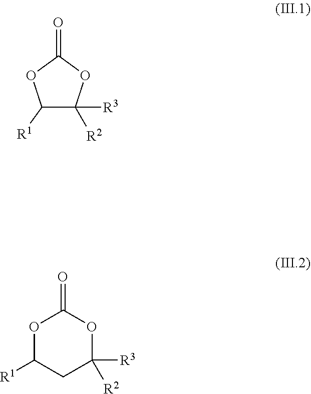

where R¹, R² and R³ can be identical or different and are selected from among hydrogen and C₁-C₄-alkyl, for example methyl, ethyl, n-propyl, isopropyl, n-butyl, isobutyl, sec-butyl and tert-butyl, with R² and R³ preferably not both being tert-butyl. In particularly preferred embodiments, R¹ is methyl and R² and R³ are each hydrogen, or R¹, R² and R³ are each hydrogen.

Another preferred cyclic organic carbonate is vinylene carbonate, Formula (IV).

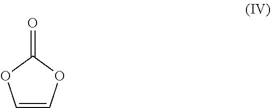

The solvent or solvents is/are preferably used in the water-free state, i.e. with a water content in the range from 1 ppm to 0.1% by weight, which can be determined, for example, by Karl-Fischer titration.

Electrolyte further comprises at least one electrolyte salt. Suitable electrolyte salts are, in particular, lithium salts. Examples of suitable lithium salts are LiPF₆, LiBF₄, LiClO₄, LiAsF₆, LiCF₃SO₃, LiC(CₙF₂ₙ₊₁SO₂)₃, lithium imides such as LiN(CₙF₂ₙ₊₁SO₂)₂, where n is an integer in the range from 1 to 20, LiN(SO₂F)₂, Li₂SiF₆, LiSbF₆, LiAlCl₄ and salts of the general formula (CₙF₂ₙ₊₁SO₂)ₜYLi, where n, t and Y are defined as follows:
t=1, when Y is selected from among oxygen and sulfur,
t=2, when Y is selected from among nitrogen and phosphorus
t=3, when Y is selected from among carbon and silicon, and
n is an integer in the range from 1 to 20.

Preferred electrolyte salts are selected from among LiC(CF₃SO₂)₃, LiN(CF₃SO₂)₂, LiPF₆, LiBF₄, LiClO₄, with particular preference being given to LiPF₆ and LiN(CF₃SO₂)₂.

In some embodiments of the present invention, cells according to the invention comprise one or more separators by means of which the electrodes are mechanically separated. Suitable separators are polymer films, in particular porous polymer films, which are unreactive toward metallic lithium. Particularly suitable materials for separators are polyolefins, in particular film-forming porous polyethylene and film-forming porous polypropylene.

Separators comprise polyolefin, in particular polyethylene or polypropylene, can have a porosity in the range of from 35% to 45%. Suitable pore diameters are, for example, in the range of from 30 nm to 500 nm.

In some other embodiments of the present invention, separators can be selected from among PET nonwovens filled with inorganic particles. Such separators can have a porosity in a range from 40% to 55%. Suitable pore diameters are, for example, in the range from 80 nm to 750 nm.

Electrochemical cells according to the invention can further comprise a housing which can have any shape, for example cuboidal or the shape of a cylindrical disk. In one variant, a metal foil configured as a pouch is used as housing. Electrochemical cells according to the invention provide a very good charge/discharge and high capacity

Batteries according to the invention can comprise two or more electrochemical cells that combined with one another, for example can be connected in series or connected in parallel. Connection in series is preferred. In batteries according to the present invention, at least one of the electrochemical cells contains at least one electrode according to the invention. Preferably, in electrochemical cells according to the present invention, the majority of the electrochemical cells contain an electrode according to the present invention. Even more preferably, in batteries according to the present invention all the electrochemical cells contain electrodes according to the present invention.

The present invention further provides for the use of batteries according to the invention in appliances, in particular in mobile appliances. Examples of mobile appliances are vehicles, for example automobiles, bicycles, aircraft or water vehicles such as boats or ships. Other examples of mobile appliances are those which move manually, for example computers, especially laptops, telephones or electric hand tools, for example in the building sector, especially drills, battery-powered screwdrivers or battery-powered staplers.

The present invention is further illustrated by working examples, but the present invention is not limited thereto.

### FIGURES

FIG. 1: The calcination profile of the TTT routine in synthesis of single crystalline NCM Ni90

FIG. 2: The calcination profile of the normal routine in synthesis of NCM Ni90

FIG. 3 (a): SEM images of the samples synthesized by the normal routines at magnifications of 10k×

FIG. 3 (b): SEM images of the samples synthesized by the normal routines at magnifications of 20k×

FIG. 3 (c): SEM images of the samples synthesized by the TTT routines at magnifications of 10k×

FIG. 3 (d): SEM images of the samples synthesized by the TTT routines at magnifications of 20k×

FIG. 4: XRD of the single crystalline NCM Ni90 synthesized by the TTT routine

FIG. 5: The calcination profiles at different TTT temperatures (830° C. (no TTT), 900° C., 970° C. and 1040° C.)

FIG. 6 (a): SEM images of the samples synthesized without TTT

FIG. 6 (b): SEM images of the samples synthesized at a TTT temperature of 900° C.

FIG. 6 (c): SEM images of the samples synthesized at a TTT temperature of 970° C.

FIG. 6 (d): SEM images of the samples synthesized at a TTT temperature of 1040° C.

FIG. 7: Pressed density comparisons of the samples synthesized at different TTT temperatures (830° C. (no TTT), 900° C., 970° C. and 1040° C.)

FIG. 8: Electrical conductivity comparisons of the samples synthesized at different TTT temperatures (830° C. (no TTT), 900° C., 970° C. and 1040° C.)

FIG. 9: The calcination profiles at various time points for transient thermal treatment

FIG. 10 (a): SEM images of the samples synthesized with step B composed of 15 mins' TTT and 10 hours' baseline heating in sequence (0 h/15 mins-TTT/10 h)

FIG. 10 (b): SEM images of the samples synthesized with step B composed of 2 hours' baseline heating, 15 mins' TTT and 8 hours' baseline heating in sequence (2 h/15 mins-TTT/8 h)

FIG. 10 (c): SEM images of the samples synthesized with step B composed of 4 hours' baseline heating, 15 mins' TTT and 6 hours' baseline heating in sequence (4 h/15 mins-TTT/6 h)

FIG. 10 (d): SEM images of the samples synthesized with step B composed of 6 hours' baseline heating, 15 mins' TTT and 4 hours' baseline heating in sequence (6 h/15 mins-TTT/4 h)

FIG. 10 (e): SEM images of the samples synthesized with step B composed of 8 hours' baseline heating, 15 mins' TTT and 2 hours' baseline heating in sequence (8 h/15 mins-TTT/2 h)

FIG. 10 (f): SEM images of the samples synthesized with step B composed of 10 hours' baseline heating and 15 mins' TTT in sequence (10 h/15 mins-TTT/0 h)

FIG. 11: Pressed density comparisons of the samples applied TTT at different time points (0 h/15 mins-TTT/10 h, 2 h/15 mins-TTT/8 h, 4 h/15 mins-TTT/6 h, 6 h/15 mins-TTT/4 h, 8 h/15 mins-TTT/2 h and 10 h/15 mins-TTT)

FIG. 12: Electrical conductivity comparisons of the samples applied TTT at different time points (0 h/15 mins-TTT/10 h, 2 h/15 mins-TTT/8 h, 4 h/15 mins-TTT/6 h, 6 h/15 mins-TTT/4 h, 8 h/15 mins-TTT/2 h and 10 h/15 mins-TTT)

### EMBODIMENT

### Embodiment 1

A process for preparing a cathode active material of Formula (I), comprising steps of

LiNiₓCo_{y}Mn_{z}O₂ (I)
i) preparing a precursor of hydroxides or carbonates of Ni, Co and Mn;
ii) mixing the precursor obtained from step i) with a source of Li; and
iii) calcining the mixture obtained from step ii), wherein said step iii) comprises multi-step calcination, wherein x is in a range of from 0.80 to 0.95 and preferably from 0.80 to 0.92, y is in a range of from 0.01 to 0.15 and preferably from 0.01 to 0.12, and z is in a range of from 0.01 to 0.15 and preferably from 0.01 to 0.12, and the sum of x, y and z is 1.

### Embodiment 2

The process according to Embodiment 1, wherein said multi-step calcination comprises a step of transient thermal treatment (TTT) to a temperature in a range of from 1000° C. to 1400° C., preferably from 1000° C. to 1200° C.

### Embodiment 3

The process according to Embodiment 2, wherein the temperature of said TTT is kept for a period of from 1 min to 1 hour, preferably from 1 min to 30 mins and more preferably from 5 mins to 20 mins.

### Embodiment 4

The process according to any one of Embodiments 1 to 3, wherein said multi-step calcination comprises a step A of heating at a temperature in a range of from 300° C. to 600° C. and preferably from 400° C. to 600° C.

### Embodiment 5

The process according to Embodiment 4, wherein said step A has a period of from 1 hours to 7 hours and preferably from 3 hours to 5 hours.

### Embodiment 6

The process according to any one of Embodiments 1 to 5, wherein said multi-step calcination comprises a step B of heating, subsequent to step A, at a temperature in a range of from 750° C. to 900° C. and preferably from 750° C. to 850° C.

### Embodiment 7

The process according to Embodiment 6, wherein said step B has a period of from 6 hours to 16 hours and preferably from 8 hours to 14 hours.

### Embodiment 8

The process according to any of Embodiments 2 to 7, wherein said TTT is carried out at any time from the beginning to the end of step B, preferably, said TTT begins at a time point of from 1/10 to 9/10, more preferably from ⅕ to ⅘ and even more preferably from ⅖ to ⅘ of the whole period of step B.

### Embodiment 9

The process according to any one of Embodiments 1 to 8, wherein the source of Li is at least one compound selected from Li₂O, LiOH and Li₂CO₃.

### Embodiment 10

A cathode active material produced by the process according to any one of Embodiments 1 to 9.

### Embodiment 11

The cathode active material according to Embodiment 10, comprising single crystalline of octahedra structures, where the lattice parameters a, b, c is 2.88047 Å, 2.88047 Å and 14.20877 Å respectively.

### Embodiment 12

The cathode active material according to Embodiment 11, wherein said single crystalline has an average particle size of from 3.5 um to 4.5 um according to PSD (particle size distribution) measurement.

### Embodiment 13

The cathode active material according to any one of Embodiments 11 to 12, wherein said single crystalline has a pressed density of from 3.0 g/ml to 4.0 g/ml tested by Powder Resistivity Measurement Unit MCP-PD51 provided by MITSUBISHI Mitsubishi Chemical Analytech Co., Ltd.

### Embodiment 14

The cathode active material according to any one of Embodiments 11 to 13, wherein said single crystalline has a conductivity of 0.004 S/m to 0.08 S/m according to JIS K7194/JIS R 1637.

### Embodiment 15

The cathode active material according to any one of Embodiments 11 to 14, comprising at least one selected from a group consisting of LiNi_{0.80}Co_{0.10}Mn_{0.10}O₂ (Ni80), LiNi_{0.83}Co_{0.12}Mn_{0.05}O₂ (Ni83), LiNi_{0.88}Co_{0.06}Mn_{0.06}O₂ (Ni88), LiNi_{0.90}Co_{0.05}Mn_{0.05}O₂(Ni90) and LiNi_{0.92}Co_{0.04}Mn_{0.04}O₂(Ni92).

### Embodiment 16

A cathode active material of Formular (1) in single crystalline of octahedra structures

LiNiₓCo_{y}Mn_{z}O₂ (I)

wherein x is in a range of from 0.80 to 0.95 and preferably from 0.80 to 0.02, y is in a range of from 0.01 to 0.15 and from 0.01 to 0.12, and z is in a range of from 0.01 to 0.15 and preferably from 0.01 to 0.12, and the sum of a, b and c is 1; wherein the lattice parameters a, b, c is 2.88047 Å, 2.88047 Å and 14.20877 Å respectively, wherein it has an average particle size of 3.5 um to 4.5 um according to PSD (particle size distribution) measurement, a pressed density of from 3.0 g/ml to 4.0 g/ml tested by Powder Resistivity Measurement Unit MCP-PD51 provided by MITSUBISHI Mitsubishi Chemical Analytech Co., Ltd. and a conductivity of 0.004 S/m to 0.08 S/m according to JIS K7194/JIS R 1637.

### Embodiment 17

The cathode active material according to Embodiment 16, comprising at least one selected from a group consisting of LiNi_{0.80}Co_{0.10}Mn_{0.10}O₂ (Ni80), LiNi_{0.83}Co_{0.12}Mn_{0.05}O₂ (Ni83), LiNi_{0.88}Co_{0.06}Mn_{0.06}O₂(Ni88), LiNi_{0.90}Co_{0.05}Mn_{0.05}O₂(Ni90) and LiNi_{0.92}Co_{0.04}Mn_{0.04}O₂(Ni92).

### Embodiment 18

A cathode comprising
(A) from 50% to 98.99% by weight of cathode active material according to any one of Embodiments 10 to 17,
(B) from 1% to 5% by weight of carbon in an electrically conductive state,
(C) from 0.01% to 5% by weight of a binder, and
(D) from 0 to 50% by weight of a solid electrolyte, based on the total weight of components (A), (B), (C) and (D).

### Embodiment 19

An electrochemical cell, comprising cathode according to Embodiment 18, anode and electrolyte.

### EXAMPLE

In the following examples, the raw material used is a Ni90 precursor prepared by the process described in Comparative Example 1 of CN113373517A, then the precursor was mixed with Li₂CO₃ in a plough-share mixer at a speed of 100 rpm for 5 mins. The obtained product has a composition of LiNi_{0.90}Co_{0.05}Mn_{0.05}O₂, and synthesized by co-precipitation, then dried without calcination. The Ni90 precursor comprises certain water or hydroxide anion.

### I. Influence of the Presence of the TTT

### Example 1

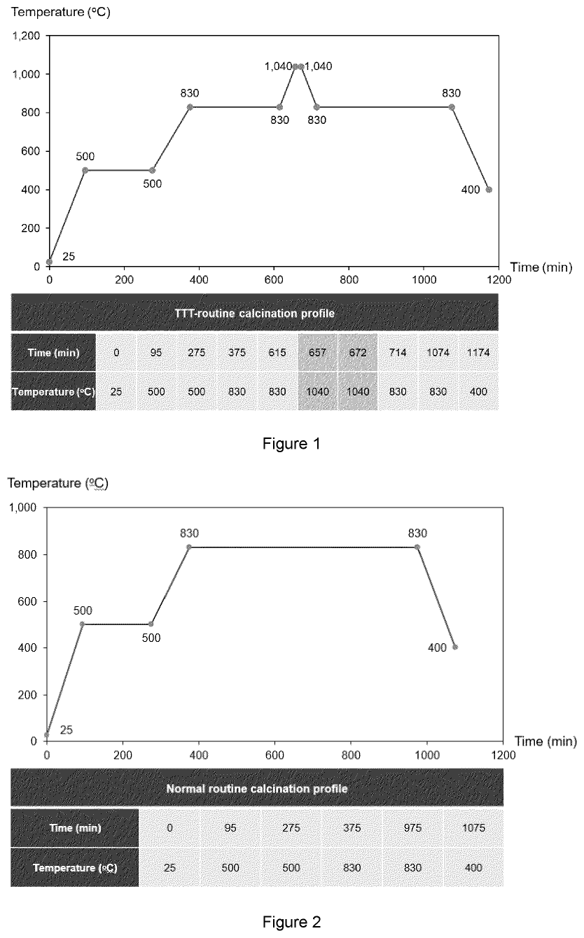

A calcination was carried out with the similar calcination profile applied as Comparative Example 1, with the only difference that a TTT was applied in the step B, as shown in FIG. 1. In detail, after a 4 h step B at 830° C., a ramp of 5° C./min was implemented to reach 1040° C., and kept under 1040° C. for 15 mins. Then, the temperature was decreased to 830° C. at the same ramp and kept under 830° C. for another 6 h. Finally, a cooling ramp of 4.3° C./min was applied to reach 400° C. and subsequently cooled down to room temperature in a natural way.

### Comparative Example 2

A normal calcination was carried out in the conventional way, i.e., in absence of the TTT. The calcination profile comprised two sectors—pre-calcination and step B, as shown in FIG. 2. Firstly, the sample was heated up from room temperature to 500° C. at a ramp of 5° C./min and stayed at 500° C. for 180 mins (3 h) to complete pre-calcination. Following that, a ramp of 3.3° C./min was applied to reach 830° C. as a step B temperature and stayed at 830° C. for 600 mins (10 h). Then, the temperature was decreased to 400° C. at a ramp of 4.3° C./min and subsequently cooled down to room temperature in a natural way.

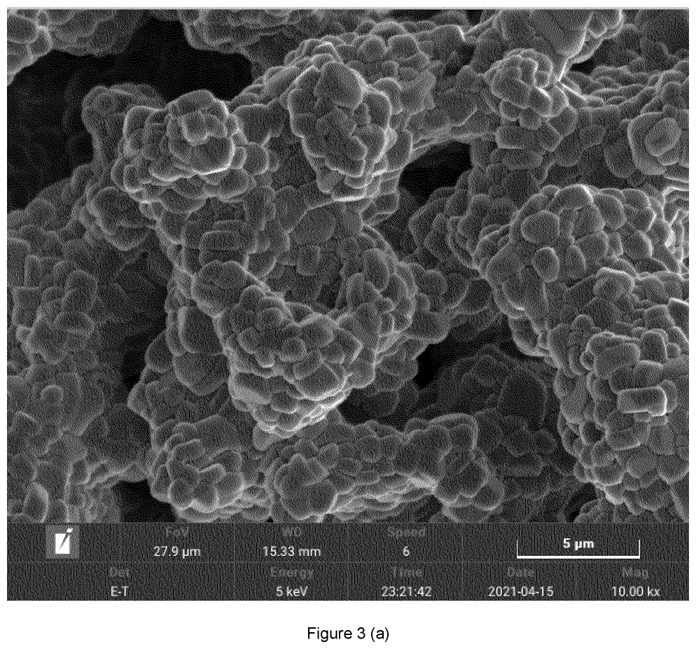

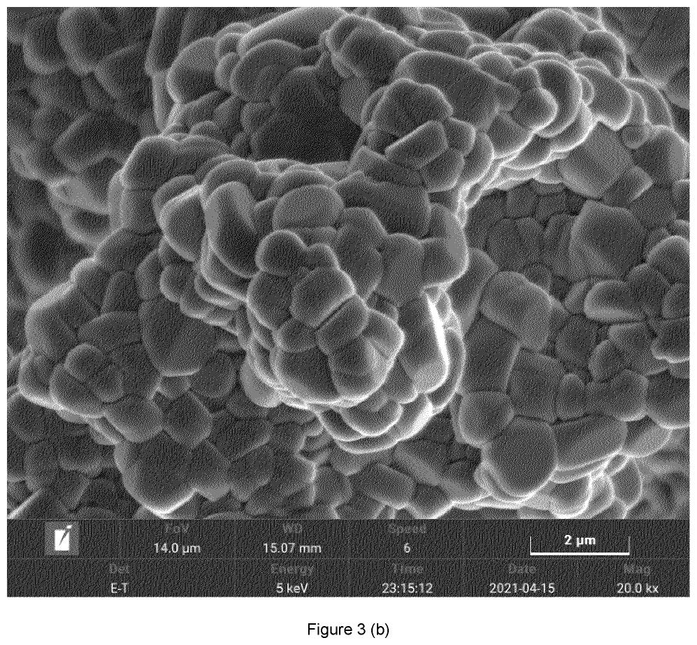

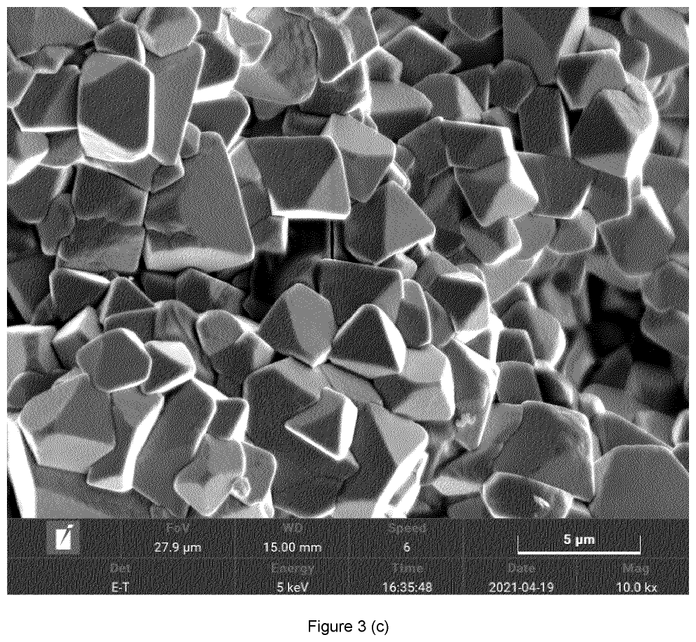

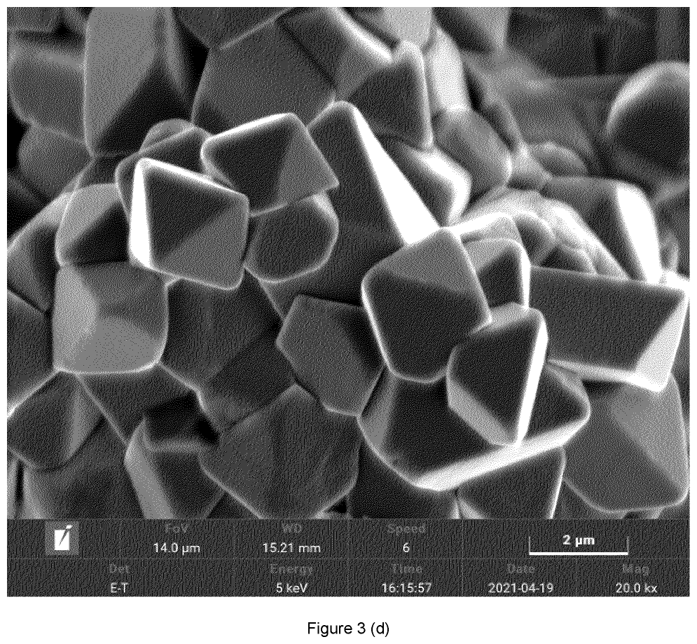

The morphology of the samples synthesized by the normal and TTT routines was studied by Scanning Electronical Microscopy (SEM) of JSM-7800, 5 keV, Working Distance (WD)=15-15.33 mm. The morphology comparison of the samples synthesized by the normal and TTT routines is shown in FIG. 3, indicating that spherical particles can be converted to octahedral particles by TTT. Moreover, the crystal size is also changed from around 1.5 um to 2.2 um. Therefore, it can be concluded that the direct impact of TTT is to form octahedron and increase particle size.

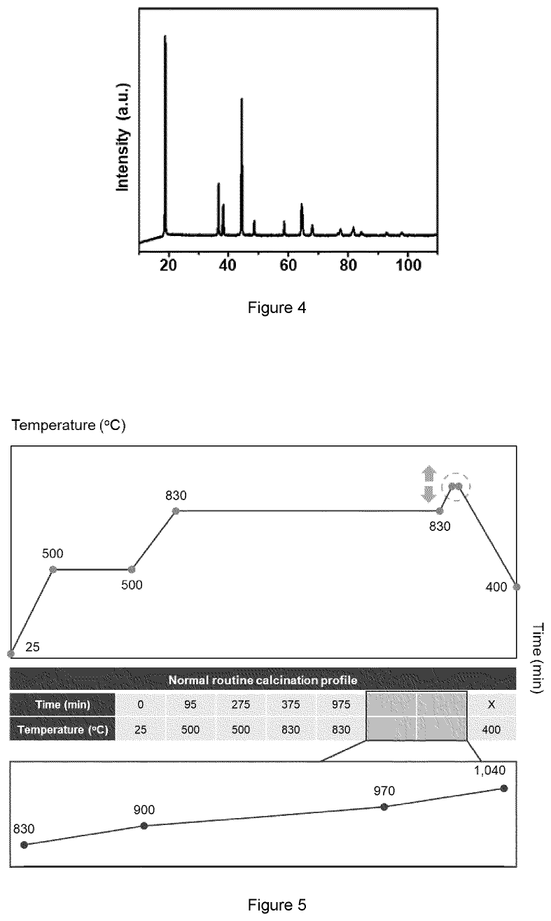

FIG. 4 shows that the XRD pattern of the TTT sample (measured by Rigaku-600 type X-ray diffractometer with Cu-Kα radiation in in the range of from 10⁰ to 110°), showing closed peak characteristics with the sample synthesized by normal one. It indicates that, although TTT gives rise to well-ordered morphology, the corresponding chemical composition in bulk is not affected.

Pressed density is a crucial indicator affecting CAM energy density. Therefore, a comparison for the samples by the TTT and normal routines are conducted by Powder Resistivity Measurement Unit MCP-PD51 from MITSUBISHI Mitsubishi Chemical Analytech Co., LTD, showing that the TTT brings a pressed density of 3.725 g/ml, 18% higher than the normal one (3.151 g/ml). Such an improvement is favorable to increase the energy density for further performance enhancement. Also, electrical conductivity is vital to reflect the electron transportation of CAM.

Electrical conductivity is measured by Powder Resistivity Measurement Unit MCP-PD51 from MITSUBISHI Mitsubishi Chemical Analytech Co., LTD, according to 4-pin probe, JIS K 7194/JIS R 1637. The TTT gives a sharp increase with a conductivity of 0.149 S/m, surprisingly 489% higher than the normal (0.025 S/m). This implies a faster and stronger electron transportation for CAM produced by the TTT.

The benefits beyond octahedral morphology are the enhancements of pressed density and electrical conductivity, implying the potentials to achieve higher energy density and faster electron transportation for CAM.

### II. Influence of the Temperature of the TTT

Three TTT temperatures were applied to investigate the influence of the temperature of TTT on morphology, pressed densities, and conductivities.

### Comparative Example 3

For comparison, a calcination experiment comprising a step B under 830° C. without the TTT was also carried out, which is indicated as “830° C.” in FIGS. 5-8.

### Comparative Example 4

A ladder experiment on TTT temperatures was conducted as show in FIG. 5. Firstly, the sample was heated up from room temperature to 500° C. at a ramp of 5° C./min and stayed at 500° C. for 180 mins (3 h) to complete pre-calcination. Following that, a ramp of 3.3° C./min was applied to reach 830° C. as a step B temperature and stayed at 830° C. for 600 mins (10 h). Then, a ramp of 5° C./min was implemented to reach 900° C. and kept under 900° C. for 15 mins. Finally, a cooling ramp of 4.3° C./min was applied to reach 400° C. and subsequently cooled down to room temperature in a natural way.

### Comparative Example 5

A ladder experiment on TTT temperatures was conducted in the same way as Comparative Example 4, with the only difference of a transient treatment temperature of 970° C.

### Example 6

A ladder experiment on TTT temperatures was conducted in the same way as Comparative Example 4, with the only difference of a transient treatment temperature of 1040° C.

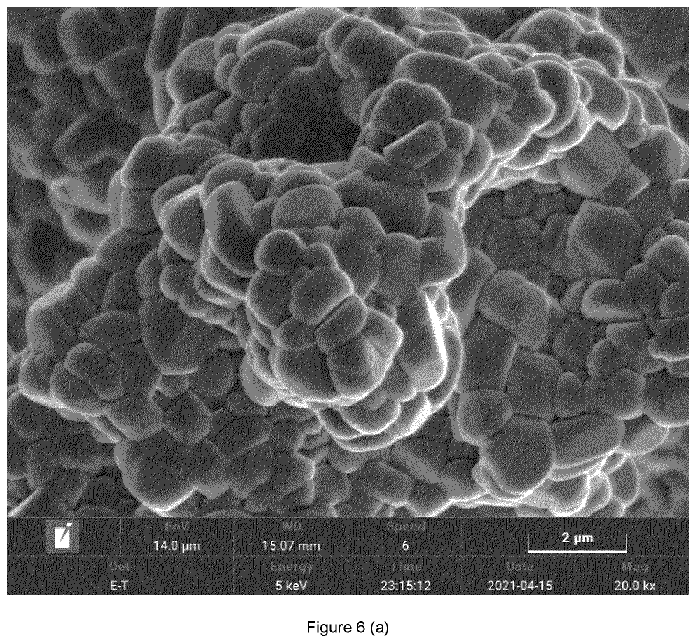

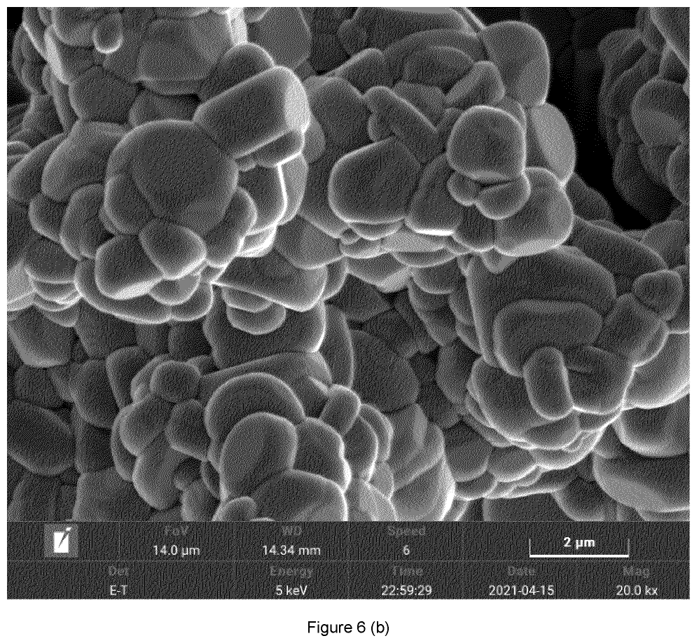

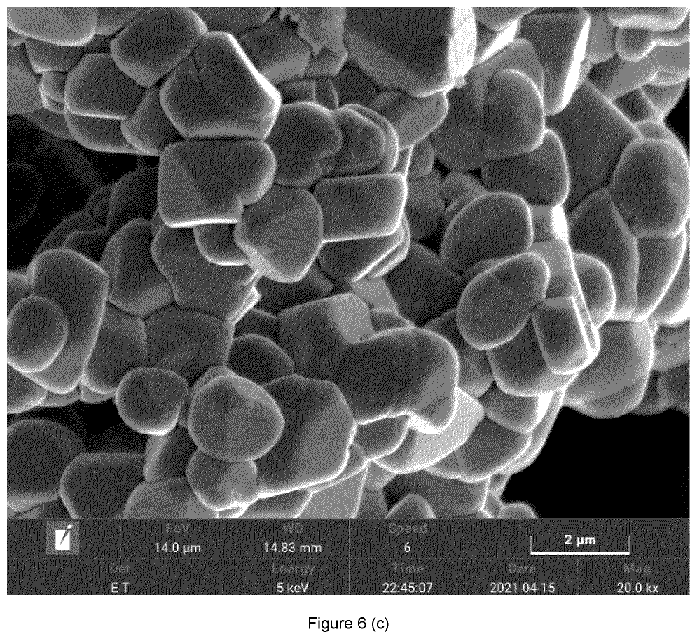

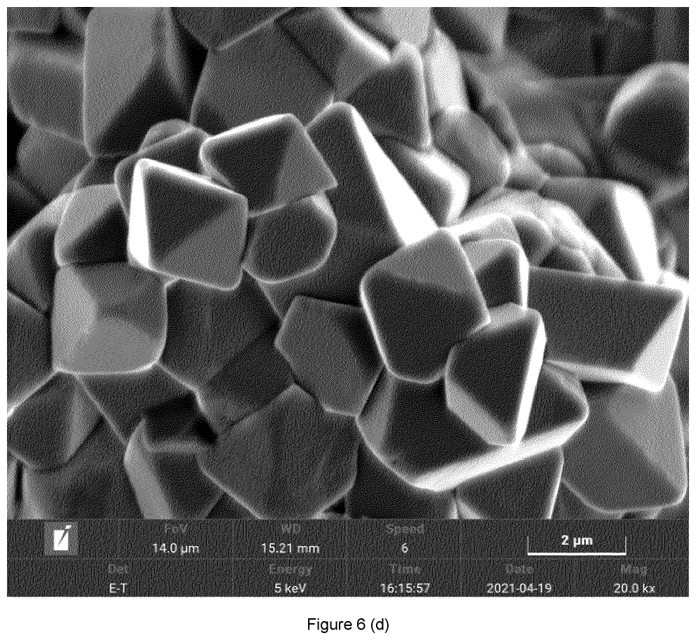

The morphologies are compared in FIG. 6, showing that, when the transient treatment temperature reaches 1040° C., octahedra can be observed from SEM images. The average particle size is around 2.6 um. In contrast, when the temperature drops to 970° C., the octahedra is disappeared. Instead, normal spheric particle is formed. This implies that 1040° C. can be the cause to form octahedra and the temperatures below 1000° C. have negligible impacts on the morphology.

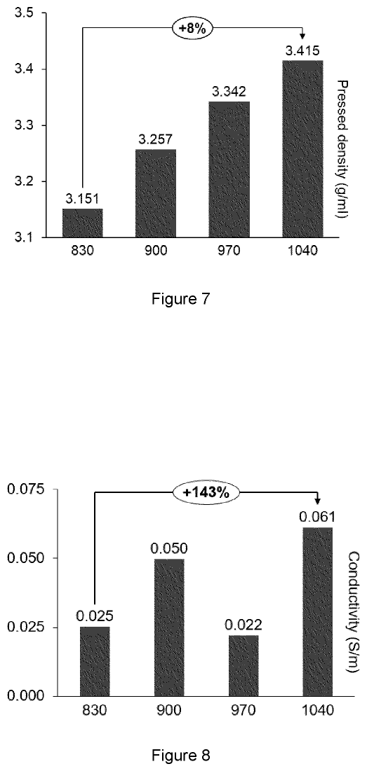

FIG. 7 is the pressed density of the four samples, showing that the sample treated at 1040° C. shows an 8% increase with an absolute value of 3.415 g/ml compared with the sample in a normal routine. Besides, a rising trend can also be visible in terms of pressed density, implying a positive correlation of transient treatment temperature and pressed densities.

The comparison of electrical conductivity for the samples is shown in FIG. 8. When 900° C. is applied for the TTT treatment, an increment of 0.025 S/m can be observed to reach 0.050 S/m.

Then, it drops back to 0.022 S/m at 970° C. Finally, when the temperature gets to 1040° C., the conductivity achieves 0.061 bringing a 143% increase compared to the normal routine. It is concluded that 1040° C. is an effective temperature to realize octahedral morphology with significant increases of the pressed density and conductivity. Besides, the trends from 830 to 1040° C. indicate that a positive correlation can be seen among temperature, morphology evolution and pressed density. In additions, although no similar correlation can be seen for conductivity, the highest value can be reached at 1040° C.

### III. Influence of the Time-Point of the TTT

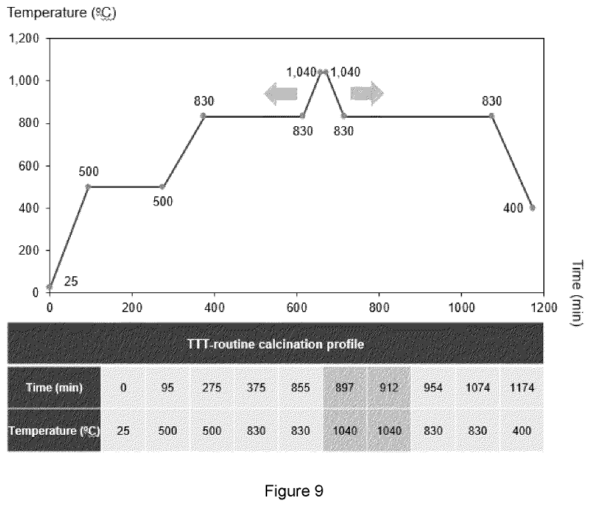

A further ladder investigation for the flexibility of 1040° C. as a TTT temperature on the step B phase was conducted as shown in FIG. 9. Six time points were applied for 15 mins TTT from the beginning to ending of the step Bs with an increment of 2 h. Also, the morphology, pressed density and conductivity were evaluated.

### Example 7

Firstly, the sample was heated up from room temperature to 500° C. at a ramp of 5° C./min and stayed at 500° C. for 180 mins (3 h) to complete pre-calcination. Following that, a ramp of 3.3° C./min was applied to reach 830° C. as a step B temperature. After 830° C. was reached, a ramp of 5° C./min was applied to reach 1040° C. as the TTT temperature and stayed at 1040° C. for 15 mins. Following that, the temperature was decreased to 830° C. at a ramp of 5° C./min and stayed at 830° C. for 600 mins (10 h). Then, the temperature was decreased to 400° C. at a ramp of 4.3° C./min and subsequently cooled down to room temperature in a natural way.

### Example 8

The same procedure as Example 7 was carried out, with the only difference that the 15 mins-TTT was applied 2 hours after the beginning of the step B.

Firstly, the sample was heated up from room temperature to 500° C. at a ramp of 5° C./min and stayed at 500° C. for 180 mins (3 h) to complete pre-calcination. Following that, a ramp of 3.3° C./min was applied to reach 830° C. as a step B temperature and stayed at 830° C. for 120 mins (2 h). Following that, a ramp of 5° C./min was applied to reach 1040° C. as the TTT temperature and stayed at 1040° C. for 15 mins. Following that, the temperature was decreased to 830° C. at a ramp of 5° C./min and stayed at 830° C. for another 480 mins (8 h). Then, the temperature was decreased to 400° C. at a ramp of 4.3° C./min and subsequently cooled down to room temperature in a natural way.

### Example 9

The same procedure as Example 7 was carried out, with the only difference that the 15 mins-TTT was applied 4 hours after the beginning of the step B.

Firstly, the sample was heated up from room temperature to 500° C. at a ramp of 5° C./min and stayed at 500° C. for 180 mins (3 h) to complete pre-calcination. Following that, a ramp of 3.3° C./min was applied to reach 830° C. as a step B temperature and stayed at 830° C. for 240 mins (4 h). Following that, a ramp of 5° C./min was applied to reach 1040° C. as the TTT temperature and stayed at 1040° C. for 15 mins. Following that, the temperature was decreased to 830° C. at a ramp of 5° C./min and stayed at 830° C. for another 360 mins (6 h). Then, the temperature was decreased to 400° C. at a ramp of 4.3° C./min and subsequently cooled down to room temperature in a natural way.

### Example 10

The same procedure as Example 7 was carried out, with the only difference that the 15 mins-TTT was applied 6 hours after the beginning of the step B.

Firstly, the sample was heated up from room temperature to 500° C. at a ramp of 5° C./min and stayed at 500° C. for 180 mins (3 h) to complete pre-calcination. Following that, a ramp of 3.3° C./min was applied to reach 830° C. as a step B temperature and stayed at 830° C. for 360 mins (6 h). Following that, a ramp of 5° C./min was applied to reach 1040° C. as the TTT temperature and stayed at 1040° C. for 15 mins. Following that, the temperature was decreased to 830° C. at a ramp of 5° C./min and stayed at 830° C. for another 240 mins (4 h). Then, the temperature was decreased to 400° C. at a ramp of 4.3° C./min and subsequently cooled down to room temperature in a natural way.

### Example 11

The same procedure as Example 7 was carried out, with the only difference that the 15 mins-TTT was applied 8 hours after the beginning of the step B.

Firstly, the sample was heated up from room temperature to 500° C. at a ramp of 5° C./min and stayed at 500° C. for 180 mins (3 h) to complete pre-calcination. Following that, a ramp of 3.3° C./min was applied to reach 830° C. as a step B temperature and stayed at 830° C. for 480 mins (8 h). Following that, a ramp of 5° C./min was applied to reach 1040° C. as the TTT temperature and stayed at 1040° C. for 15 mins. Following that, the temperature was decreased to 830° C. at a ramp of 5° C./min and stayed at 830° C. for another 120 mins (2 h). Then, the temperature was decreased to 400° C. at a ramp of 4.3° C./min and subsequently cooled down to room temperature in a natural way.

### Example 12

The same procedure as Example 7 was carried out, with the only difference that the 15 mins-TTT was applied 10 hours after the beginning of the step B, i.e., at the ending of the step B.

Firstly, the sample was heated up from room temperature to 500° C. at a ramp of 5° C./min and stayed at 500° C. for 180 mins (3 h) to complete pre-calcination. Following that, a ramp of 3.3° C./min was applied to reach 830° C. as a step B temperature and stayed at 830° C. for 600 mins (10 h). Following that, a ramp of 5° C./min was applied to reach 1040° C. as the TTT temperature and stayed at 1040° C. for 15 mins. Following that, the temperature was decreased to 830° C. at a ramp of 5° C./min. Then, the temperature was decreased to 400° C. at a ramp of 4.3° C./min and subsequently cooled down to room temperature in a natural way.

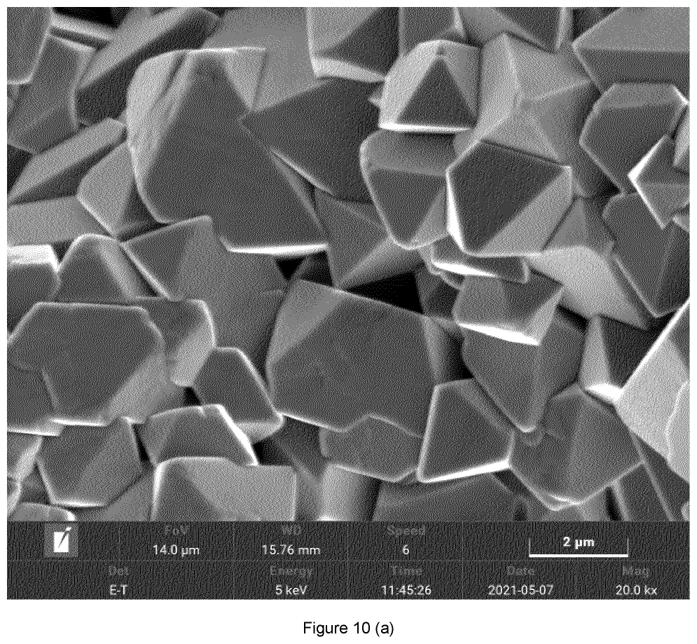

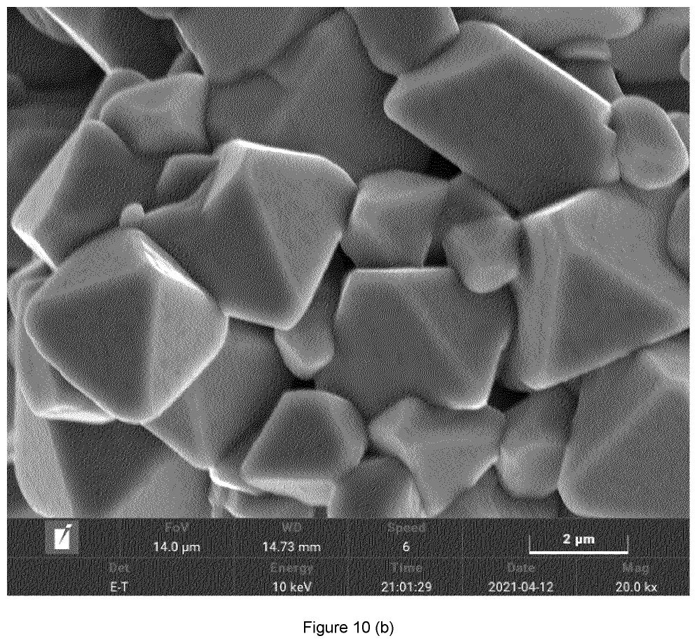

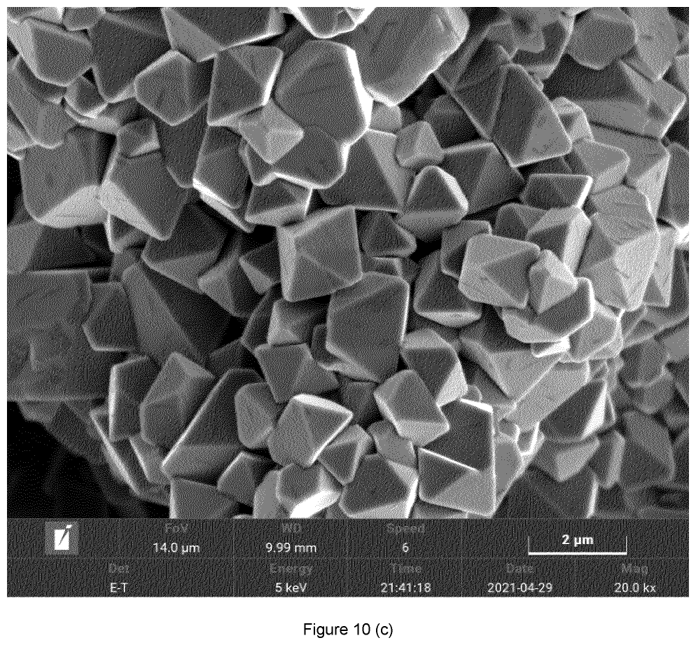

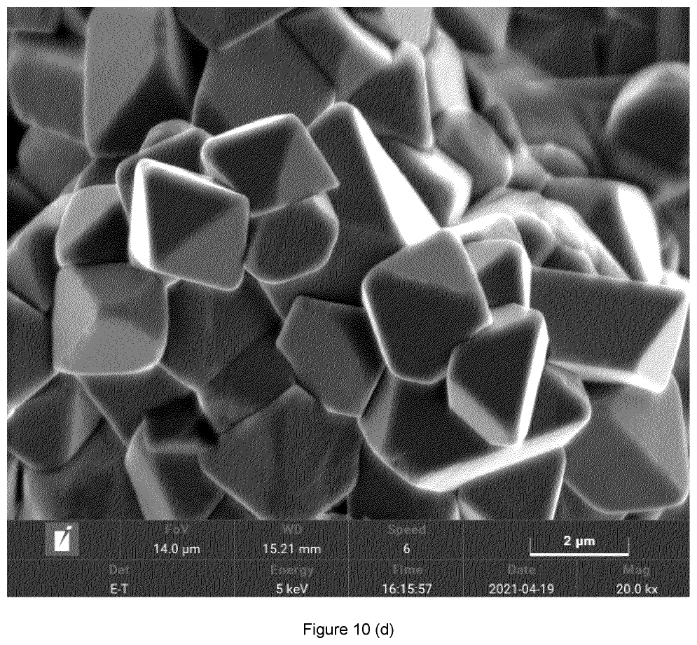

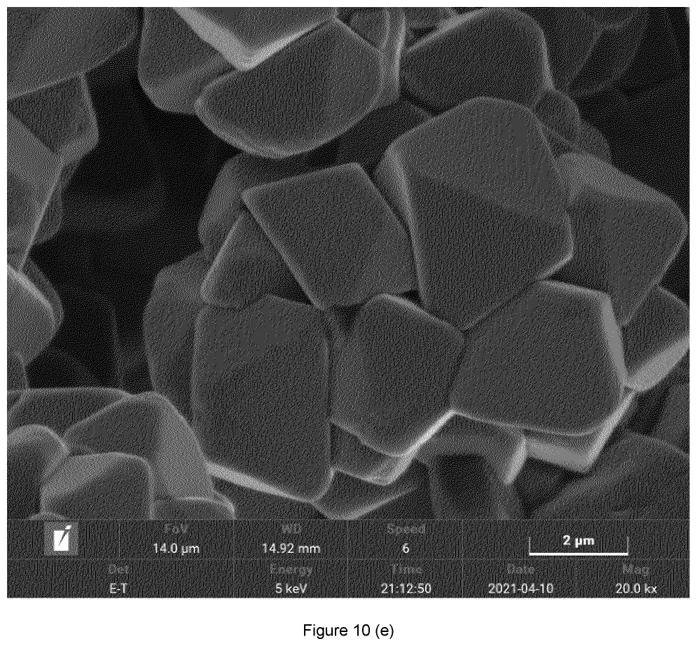

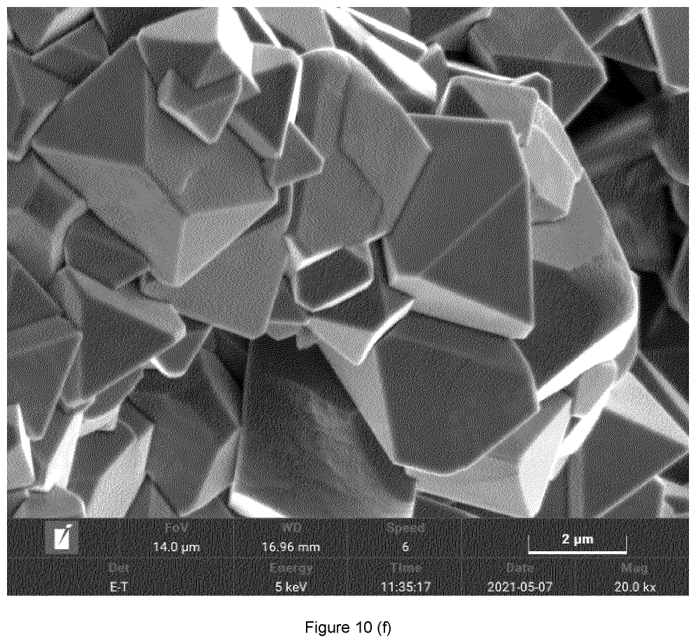

FIG. 10 is the collection of the morphologies at various TTT time points, showing closed octahedrons but different particle size. The size at around 3.5 um can be seen for the samples treated at 15 mins-TTT/10 h, 2 h/15 mins-TTT/8 h, 8 h/15 mins-TTT/2 h and 10 h/15 mins-TTT, whereas the smaller can be seen for the samples treated at 4 h/15 mins-TTT/6 h, 6 h/15 mins-TTT/4 h especially the 4 h/15 mins-TTT/6 h one displaying the size around 2.0 um.

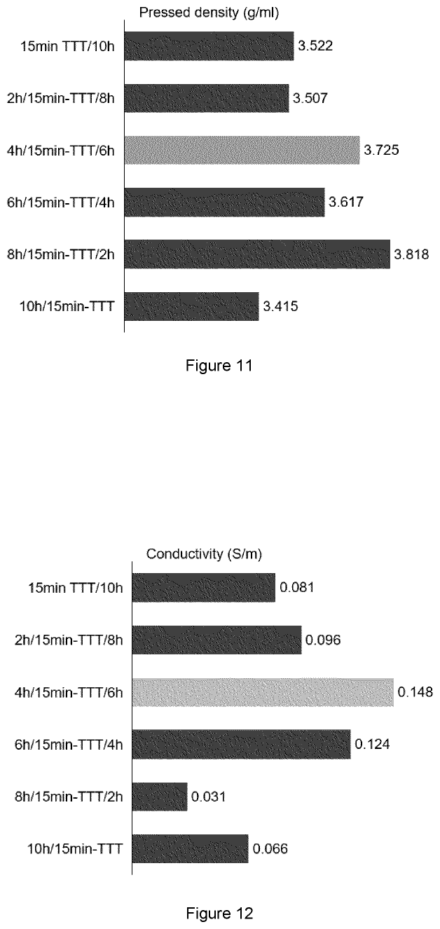

The comparison of the pressed density is shown in FIG. 11, indicating that all samples own higher (>3.4 g/ml) pressed densities compared with the normal, confirming the impact of TTT again. Among them, the samples treated at 4 h/15 mins-TTT/6 h and 8 h/15 mins-TTT/2 h give first two values that are 3.725 and 3.818 g/ml.

When it comes to electrical conductivity, as shown in FIG. 12, from the beginning to ending for the TTT time points, the values firstly increase from 0.081 to 0.096 to 0.148 S/m and then drop to 0.124 to 0.031 S/m, and finally reach 0.066 S/m. The highest one (0.148 S/m) is from the sample treated at 4 h/15 mins-TTT/6 h.

1. A process for preparing a cathode active material of formula (I): LiNiₓCo_{X}Mn_{z}O₂ (I), comprising steps of:
i) preparing a precursor of hydroxides or carbonates of Ni, Co and Mn;
ii) mixing the precursor obtained from step i) with a source of Li; and
iii) calcining the mixture obtained from step ii), wherein said step iii) comprises multi-step calcination,
wherein x is in a range of from 0.80 to 0.95, y is in a range of from 0.01 to 0.15, and z is in a range of from 0.01 to 0.15, and a sum of x, y and z is 1.

2. The process according to claim 1, wherein said multi-step calcination comprises a step of transient thermal treatment (TTT) to a temperature in a range of from 1000° C. to 1400° C.

3. The process according to claim 2, wherein the temperature of said TTT is kept for a period of from 1 minute to 1 hour.

4. The process according to claim 1, wherein said multi-step calcination comprises a step A of heating at a temperature in a range of from 300° C. to 600° C.

5. The process according to claim 4, wherein said step A has a period of from 1 hours to 7 hours.

6. The process according to claim 1, wherein said multi-step calcination comprises a step B of heating, subsequent to step A, at a temperature in a range of from 750° C. to 900° C.

7. The process according to claim 6, wherein said step B has a period of from 6 hours to 16 hours.

8. The process according to claim 2, wherein said TTT is carried out at any time from the beginning to the end of step B.

9. The process according to claim 1, wherein the source of Li is at least one compound selected from the group consisting of Li₂O, LiOH, and Li₂CO₃.

10. A cathode active material produced by the process according to claim 1.

11. The cathode active material according to claim 10 comprising a single crystalline of octahedra structures, wherein lattice parameters a, b, c are 2.88047 Å, 2.88047 Å and 14.20877 Å respectively.

12. The cathode active material according to claim 11, wherein said single crystalline has an average particle size of from 3.5 μm to 4.5 μm according to PSD (particle size distribution) measurement.

13. The cathode active material according to claim 11, wherein said single crystalline has a pressed density of from 3.0 g/ml to 4.0 g/ml tested by Powder Resistivity Measurement Unit MCP-PD51 provided by MITSUBISHI Mitsubishi Chemical Analytech Co., Ltd.

14. The cathode active material according to claim 11, wherein said single crystalline has a conductivity of 0.0045/m to 0.08 S/m according to JIS K7194/JIS R 1637.

15. The cathode active material according to claim 11, further comprising at least one selected from the group consisting of LiNi_{0.80}Co_{0.10}Mn_{0.10}O₂(Ni80), LiNi_{0.83}Co_{0.12}Mn_{0.05}O₂(Ni83), LiNi_{0.88}Co_{0.06}Mn_{0.06}O₂ (Ni88), LiNi_{0.90}Co_{0.05}Mn_{0.05}O₂ (Ni90), and LiNi_{0.92}Co_{0.04}Mn_{0.04}O₂ (Ni92).

16. A cathode active material of formula (I) in a single crystalline of octahedra structures:
LiNiₓCo_{y}Mn_{z}O₂ (I)
wherein x is in a range of from 0.80 to 0.95, y is in a range of from 0.01 to 0.15, and z is in a range of from 0.01 to 0.15, and a sum of a, b and c is 1, wherein lattice parameters a, b, c are 2.88047 Å, 2.88047 Å and 14.20877 Å respectively, and wherein the single crystalline has an average particle size of 3.5 μm to 4.5 μm according to PSD (particle size distribution) measurement, a pressed density of from 3.0 g/ml to 4.0 g/ml tested by Powder Resistivity Measurement Unit MCP-PD51 provided by MITSUBISHI Mitsubishi Chemical Analytech Co., Ltd., and a conductivity of 0.0045/m to 0.085/m according to JIS K7194/JIS R 1637.

17. The cathode active material according to claim 16 comprising at least one selected from the group consisting of LiNi_{0.80}Co_{0.10}Mn_{0.10}O₂ (Ni80), LiNi_{0.83}Co_{0.12}Mn_{0.05}O₂(Ni83), LiNi_{0.88}Co_{0.06}Mn_{0.06}O₂ (Ni88), LiNi_{0.90}Co_{0.05}Mn_{0.05}O₂ (Ni90), and LiNi_{0.92}Co_{0.04}Mn_{0.04}O₂ (Ni92).

18. A cathode comprising:
(A) from 90% to 98.99% by weight of the cathode active material according to claim 16;
(B) from 1% to 5% by weight of carbon in an electrically conductive state,
(C) from 0.01% to 5% by weight of a binder, and
(D) from 0 to 50% by weight of a solid electrolyte, based on a total weight of components (A), (B), (C), and (D).

19. An electrochemical cell comprising the cathode according to claim 18, an anode, and an electrolyte.

20. The process according to claim 1, wherein x is in a range of from 0.80 to 0.92, y is in a range of from 0.01 to 0.12, and z is in a range of from 0.01 to 0.12.
